(19) United States
(12) Patent Application Publication
(10) Pub. No.: US 2014/0145801 A1
(43) Pub. Date: May 29, 2014

(54) MAGNETIC ACTUATOR WITH ROTATABLE ARMATURE

(71) Applicant: ABB TECHNOLOGY AG, Zurich (CH)

(72) Inventors: Christian Reuber, Willich (DE); Wenkai Shang, Ratingen (DE)

(73) Assignee: ABB TECHNOLOGY AG, Zurich (CH)

(21) Appl. No.: 14/167,398

(22) Filed: Jan. 29, 2014

Related U.S. Application Data
(63) Continuation of application No. PCT/EP2011/003812, filed on Jul. 29, 2011.

(51) Int. Cl. H01H 71/24

(52) U.S. Cl. CPC H01H 71/2472
USPC 335/38

(57) ABSTRACT

A magnetic actuator with a movable part and a non-movable part is disclosed. The movable part can include two rotatable ferromagnetic elements with a portion close to the non-movable part to reduce magnetic force acting on the movable part during a switching operation, while moving the movable part towards the non-movable part. As the distance between the movable part and the non-movable part is reduced, a current through a coil of the non-movable part for generating magnetic force for acting on the movable part during a switching operation.

### RELATED APPLICATION

This application claims priority as a continuation application under 35 U.S.C. §120 to PCT/EP2011/003812 filed as an International Application on Jul. 29, 2012 designating the U.S., the entire content of which is hereby incorporated by reference in its entirety.

### FIELD

The present disclosure relates to a magnetic actuator for a circuit breaker, and a circuit breaker with a magnetic actuator.

### BACKGROUND INFORMATION

Magnetic actuators are used for opening and closing electrical circuits. Therefore, armatures of the magnetic actuator move up and down along an axis of the magnetic actuator.

A magnetic actuator basically includes a core element, one or more permanent magnets, a flank, one or more coils, a movable on-plate, a movable off-plate, and a movable axis which connects the on-plate to the off-plate. The core element, the permanent magnet, the flank, and the coil are combined to form a non-movable part, while the on-plate, the off-plate, and the axis are combined to form a movable part.

By moving the movable part, the magnetic actuator can be switched from an off-position to an on-position, and vice versa.

### SUMMARY

A magnetic actuator is disclosed for a circuit breaker, comprising: a non-movable part; and a movable part having a first element and a second element, the movable part being movable in a first direction from an off-position to an on-position; wherein in the off-position the non-movable part is adjacent to the first element; wherein in the on-position the non-movable part is adjacent to the second element; wherein the first element and/or the second element are configured to rotate around a rotational axis when a magnetic force generated by the non-movable part acts on the first element and/or the second element and the movable part moves from the off-position to the on-position; and wherein in the off-position or in the on-position the first direction is not perpendicular to a surface of the first element and/or the second element facing the non-movable part.

### BRIEF DESCRIPTION OF THE DRAWINGS

These and other aspects of the present invention will become apparent from and elucidated with reference to the embodiments described herein. Exemplary embodiments will be described in the following with reference to the following drawings, wherein:

FIG. 1 illustrates a magnetic actuator according to an exemplary embodiment disclosed herein;

FIG. 2 illustrates a magnetic actuator according to a further exemplary embodiment disclosed herein;

FIG. 3 illustrates a magnetic actuator according to a further exemplary embodiment disclosed herein;

FIG. 4 illustrates a magnetic actuator according to a further exemplary embodiment disclosed herein;

FIG. 5 illustrates a magnetic actuator according to a further exemplary embodiment disclosed herein;

FIG. 6 illustrates a magnetic actuator according to a further exemplary embodiment disclosed herein;

FIG. 7 illustrates a magnetic actuator according to a further exemplary embodiment disclosed herein;

FIG. 8 illustrates a magnetic actuator according to a further exemplary embodiment disclosed herein; and

FIG. 9 illustrates a magnetic actuator according to a further exemplary embodiment disclosed herein;

It should be noted that the same reference signs may be used for similar or identical elements.

### DETAILED DESCRIPTION

A magnetic actuator is disclosed which can switch more efficiently.

According to an aspect of the present disclosure, a magnetic actuator for a circuit breaker can include a non-movable part and a movable part. The movable part can include a first element and a second element, and the movable part is movable in a first direction from an off-position to an on-position, wherein in the off-position the non-movable part is adjacent to the first element, and wherein in the on-position the non-movable part is adjacent to the second element. The first element and/or the second element are adapted to rotate around a rotational axis when a magnetic force generated by the non-movable part acts on the first element and/or the second element and the movable part moves from the off-position to the on-position. In the off-position or in the on-position the first direction is not perpendicular to a surface of the first element and/or the second element facing the non-movable part. In other words, there is an inclination angle between the first direction and the first element and/or the second element.

Thus, the current supplied for the coil to start the switching operation may be reduced without reducing the working stroke of the magnetic actuator as compared to actuators with parallel first element and second element, which elements may be an on-plate and an off-plate, respectively.

The first element and/or the second element can be at least partially made of any ferromagnetic materials, such as iron or steel, for example. The first element and/or the second element may be plates or bars of any geometrical shape adapted to be attracted by a magnetic force generated by the non-movable part, so that a switching operation of the magnetic actuator is performed.

The moving of the movable part in a first direction from an off-position to an on-position represents the working stroke of the magnetic actuator. The magnetic actuator may generate a high static holding force in the on-position, to keep the magnetic actuator in a closed state.

As the first direction is not perpendicular to the surface of the first element and/or the second element facing the non-movable part, at least a part of the first element and/or the second element is closer to the non-movable part in the on-position and the off-position, respectively. Thus, the magnetic flux of the permanent magnets and the coil can find a shorter way to the first element and/or the second element, so that less current can be supplied in the coil to start the moving of the movable part (e.g., to perform a switching operation).

The first element and/or the second element may be adapted (e.g., configured) to rotate around a rotational axis as soon as the closest part of the first element and/or and the second element to the non-movable part strikes against the surface of the non-movable part so that the moving of the movable part may be continued and the working stroke of the magnetic actuator is not reduced.

Thus, a rotational or flap-type movement of the first element and/or the second element is foreseen. The first element and the second element may rotate around a first rotational axis and a second rotational axis, respectively.

In a default state of the magnetic actuator, the movable part may be arranged such that the first element and/or the second element are adjacent to the non-movable part or such that neither the first element nor the second element is adjacent to the non-movable part. In other words, the non-movable part may lie in between the first element and the second element with a predetermined distance between the non-movable part and both, the first element and the second element.

A magnetic actuator as described herein may be in the default state in an off-state or in an on-state. In other words, the magnetic actuator may open or close an electrical circuit when performing a switching operation.

According to an exemplary embodiment, the first element and the second element are interlinked so that the first element and the second element both rotate around the rotational axis.

The first element and the second element may be interlinked to form the shape of a horseshoe, for example. Thus, the horseshoe-shaped first element and second element may rotate in common around one rotational axis.

The rotational axis may be located at any position in or near the first element or the second element.

According to a further exemplary embodiment, the movable part can include a mechanical interlink, wherein the first element and the second element are interlinked with the mechanical interlink for coupling the first element to the second element.

The mechanical interlink may be adapted to transmit attraction force and/or compressive force from the first element to the second element or from the second element to the first element, so that both, the second element and the first element move, when at least one of the first element and the second element are attracted by the non-movable part.

According to a further exemplary embodiment, the mechanical interlink is a shaft. A longitudinal axis of the shaft runs parallel to the first direction and the shaft is arranged between the first element and the second element, and is connected to the first element and/or the second element by means of a first hinge and a second hinge, respectively.

The first hinge and the second hinge permit a linear compensation movement of the movable part in order to avoid a clamping of the movable parts with a non-movable part.

The mechanical interlink may be directed through the non-movable part or close to the non-movable part.

According to a further exemplary embodiment, the first element and/or the second element can include an oblong hole, wherein a part of the mechanical interlink is adapted to move in the oblong hole when the first element and/or the second element rotate around the rotational axis when moving into the first direction.

A long side of the oblong hole may be perpendicular or inclined with respect to the first direction.

The first hinge and the second hinge may be pins for interconnecting the first element and/or the second element and the shaft through the oblong hole.

According to a further exemplary embodiment of the invention, the movable part can include at least one stop element for stopping a rotation of the first element and/or the second element around the rotational axis. The stop element may be adapted to hold the first element and/or the second element in an inclined position relative to the first direction in the on-position and the off-position, respectively.

The stop element may be located at the first element, the second element or the mechanical interlink. The stop element may be adapted to define a maximum inclination angle between the first element and/or the second element and the mechanical interlink.

For example, when the rotational axis of the first element and/or the second element coincides with the hinge, the stop element may be used to determine the inclination angle between the first element and/or the second element and the mechanical interlink. In this case, a part of the first element and/or the second element may be weighted or charged, so that the first element and/or the second element assume an inclined position with respect to the mechanical interlink when the non-movable part is not adjacent to the first element and the second element, respectively.

According to a further exemplary embodiment, the movable part can include a first spring to bring the first element and/or the second element in the inclined position.

The spring may be any tension spring adapted to put a tension force to the first element and/or the second element. Thus, the spring brings the first element and/or the second element in the inclined position, wherein the stop element as described herein holds the first element and/or the second element in the predetermined inclined position.

According to an exemplary embodiment, the non-movable part can include a core element, at least one permanent magnet and a first coil, wherein a current flows through the first coil to generate a magnetic attractive force acting on the second element so that the movable part moves to the on-position.

The magnetic actuator as described herein may also include two or more permanent magnets, which permanent magnets are located at different positions within the magnetic circuit. As a matter of course, the non-movable part may also be designed without permanent magnets. In this case, the first coil may be adapted to generate a stronger magnetic field, so that the movable part can be forced to move.

According to a further exemplary embodiment, the magnetic actuator can include at least one flank, which at least one flank is elongated in a direction parallel to the first direction so that a distance from the movable part to the non-movable part is reduced in order to reduce a magnetic resistance of an air gap between the movable part and the non-movable part.

The reduced magnetic resistance of the air gap can lead to a reduced current in the coil for generating the magnetic field to perform a switching operation of the magnetic actuator. The flank may be elongated towards the first element and/or the second element. The flank may have an offset perpendicular to the first direction so that the working stroke of the magnetic actuator is not reduced.

In other words, the flank is aside the first element and/or the second element, wherein the flank has an offset with respect to the first element and/or the second element perpendicular to the first direction.

According to an exemplary embodiment, the non-movable part can include a second coil, wherein a current flows through the second coil to obtain a magnetic attractive force at the first element so that the movable part moves to the off-position.

In other words, the first coil may be adapted to perform a switch-on process, and the second coil may be adapted to perform a switch-off process of the magnetic actuator as described herein.

According to a further exemplary embodiment, the magnetic actuator can include a second spring, which second spring is arranged to move the movable part to the off-position.

The second spring may support or substitute the second coil.

The second spring may be adapted so that the tension force exerted to the movable part is negligible in the off-position. Thus, when starting a switching operation, the second spring does not impede the moving of the movable part when being attracted by the non-movable part. The more the movable part moves towards the non-movable part, the stronger becomes the magnetic force and thus being able to overcome the opposed tension force of the second spring, as the magnetic force increases exponentially with decreasing distance, and the tension force of the second spring increases linearly when being expanded or stretched.

According to a further exemplary embodiment, a circuit breaker with a magnetic actuator as described herein is provided.

In an exemplary off-position of a magnetic actuator, the movable off-plate is close to the non-movable part, while the movable on-plate is a certain distance away from the non-movable part.

In contrast, the movable on-plate is, for example, close to the non-movable part in the on-position, while the movable off-plate is a certain distance away from the non-movable part.

The coil can be adapted (e.g., configured) to generate the magnetic force in a way that the movable on-plate is attracted to the non-movable part so that a switching operation of the magnetic actuator is achieved. In other words, the magnetic flux generated by the permanent magnets and the coil is distributed in order to attract the movable part towards the non-movable part. The magnetic flux may be distributed from the permanent magnets through the core element and crossing the distance between the non-movable part and the movable part to the on-plate and the off-plate, respectively, passing the on-plate and the off-plate, respectively, and crossing the distance from the movable part to the non-movable part and reaching the permanent magnet via the flank.

As the direction of the magnetic flux does not have an influence on the magnetic attraction between the movable part and the non-movable part, it can also be opposite to the description above.

As the distance between the on-plate and the off-plate, respectively, and the non-movable part can represent a relatively high magnetic resistance, a magnetic force for attracting the movable part depends on this distance. The strongest force is obtained when the distance is virtually zero, as it is the case in the on-position, for example.

When the magnetic actuator is in the off-position and it shall be closed, an electrical current should flow through the coil in a way that the magnetic flux of the permanent magnet is supported and increased, so that the non-movable part will more strongly attract the movable part. With a certain current, the attractive magnetic force can become strong enough to move the movable part against further external forces and masses, so that the magnetic actuator can reach the on-position, for example.

The magnetic flux can pass the distance between the movable part and the non-movable part twice. A certain fraction of the magnetic flux, the so-called stray flux, may go directly from the core to the nearest flank. As this stray flux does not interact with the movable part, it does not contribute to the magnetic force that attracts the movable part to the non-movable part. The percentage of this fraction of flux, compared to the total flux, depends on the distance between the core and the nearest flank as the distance between the movable part and the non-movable part. For example, the stray flux percentage will increase with larger distances between the movable part and the non-movable part, as air has a very high magnetic resistance compared to iron, for example. As a result, the current that has to flow through the coil to obtain a certain attractive magnetic force at the movable part has to be much higher for higher working strokes of the magnetic actuator.

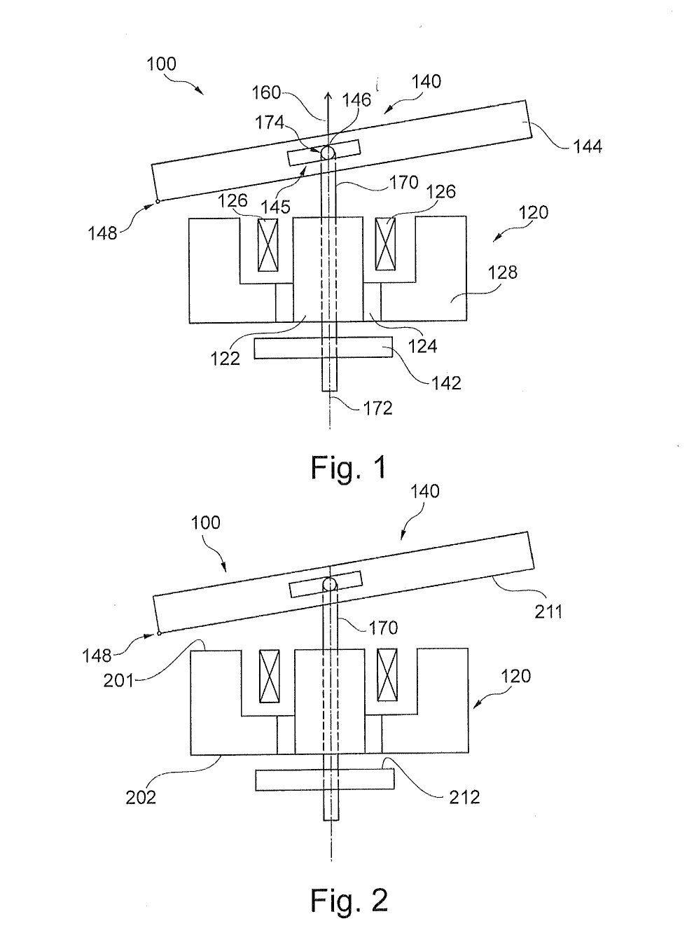

FIG. 1 illustrates an exemplary magnetic actuator 100 with a non-movable part 120 and a movable part 140. The non-movable part 120 includes a core element 122, a permanent magnet 124, a coil 126, and a flank 128. The movable part 140 comprises a first element 142, a second element 144, and a shaft 170.

The coil 126 is wound around the core element 122 and is adapted to generate a magnetic force for attracting the second element 144 towards the non-movable part.

The first element 142 and the second element 144 are interlinked with a shaft 170, which shaft is directed through the core element 122 of the non-movable part. The shaft 170 is movable in a first direction 160 parallel to a longitudinal axis 172 of the shaft. The first element 142 is perpendicular to the longitudinal axis 172, whereas the second element 144 is not perpendicular to the longitudinal axis 172. The second element 144 is inclined with respect to the shaft 170.

The shaft 170 and the second element 144 are connected by means of a hinge 174, wherein the hinge 174 is adapted to move in an oblong hole 145 when the shaft 170 moves in the direction 160 and the second element 144 rotates around the rotational axis 148.

The oblong hole 145 and the hinge 174 with its mounting point 146 to the shaft 170 permit a linear compensation movement to avoid a clamping of the movable parts and the non-movable parts while moving the movable part in the direction 160.

Even though FIG. 1 shows only one rotationally mounted element, both, the first element 142 and the second element 144 may be adapted to rotate around a first rotational axis and a second rotational axis, respectively, when the movable part is moved along the first direction 160.

FIG. 2 illustrates another exemplary embodiment of the magnetic actuator 100 with a non-movable part 120 and a movable part 140.

The rotational axis 148 may be arranged such that the rotational axis is at the same level with a surface 201 of the non-movable part 120 with respect to the first direction 160 or the longitudinal axis of the shaft 170. In other words, there is no offset along the first direction between the axis 148 and the surface 201. When starting a switching operation, the second element 144 is attracted towards the non-movable part 120 and the movable part stops moving when a surface 211 of the second element 144 lies planar against the surface 201 of the non-movable part. A second surface 202 of the non-movable part 120 and a surface 212 of the first element may be adjacent or spaced apart in the default state of the magnetic actuator.

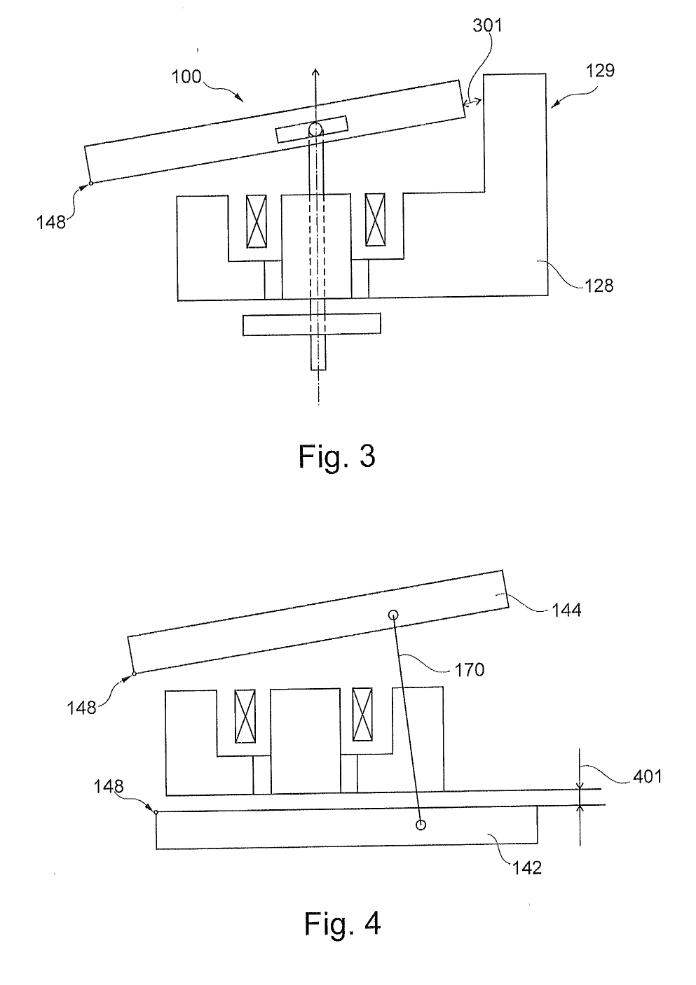

FIG. 3 shows a magnetic actuator 100 with an elongated flank 128, wherein an elongated part 129 of the elongated flank 128 is elongated towards the second element in order to reduce the air gap 301 between the non-movable part and the movable part such that the magnetic resistance of the air gap 301 is reduced. The flank 128 is elongated such that the working stroke of the magnetic actuator is not reduced. The elongated part 129 of the flank 128 is located close to the movable part with an offset in a radial direction of the shaft 170. Thus, the second element moves along the elongated flank while rotating around the rotational axis 148.

FIG. 4 shows an exemplary embodiment of a magnetic actuator, a first element 142 and a second element 144, wherein the first element and the second element are connected with a mechanical interlink 170. Both, the first element 142 and the second element 144 are adapted to rotate around a first rotational axis 148 and a second rotational axis 148.

In an exemplary default state of the magnetic actuator, none, one or both, the first element 142 and the second element 144 may be inclined with respect to the moving direction of the movable part. In the default state of the magnetic actuator, the first element 142 and/or the second element 144 may be located adjacent or close to the non-movable part such that there is a predetermined distance 401 between the first element and/or the second element and the non-movable part.

The mechanical interlink 170 can be inside or outside of the non-movable part. The mechanical interlink may support a consistent movement of the movable part.

The mechanical interlink 170 may consist physically of one or more links; e.g., one link each at the left and at the right side of the actuator.

The movable part of the magnetic actuator as described above and herein may be in the default state in the off-position or in the on-position of the magnetic actuator. Thus, the switching operation may close and break an electrical circuit, respectively.

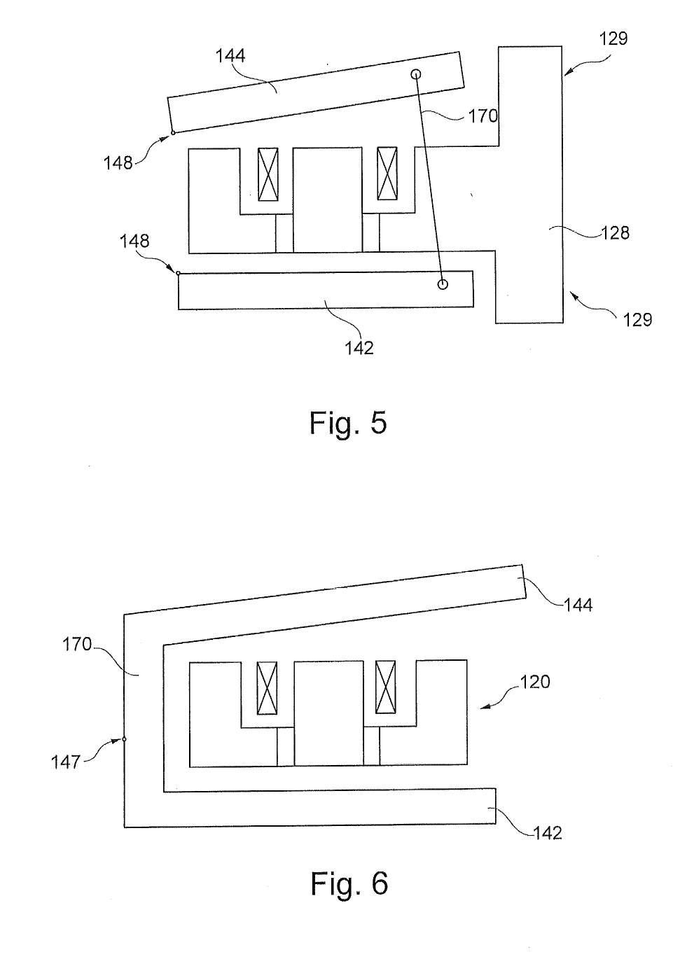

FIG. 5 illustrates an exemplary embodiment of the magnetic actuator 100, wherein the flank 128 elongates towards both the first element 142 and the second element 144.

The first element 142 and the second element 144 are connected with the mechanical interlink 170, and while moving the movable part each of the elements rotates around the rotational axis 148.

An exemplary advantage as described with FIG. 3, is that the reduction of the airgap for the magnetic flux applies to both the first and the second element 142, 144.

FIG. 6 illustrates another exemplary embodiment of a magnetic actuator, wherein the first element 142 and the second element 144 are interlinked such that the movable part is U-form-shaped or horseshoe-shaped.

The first element 142 and the second element 144 are interlinked with an interlink 170 such that the first element, the second element and the interlink rotate around the rotational axis 147 when the movable part is attracted by the non-movable part.

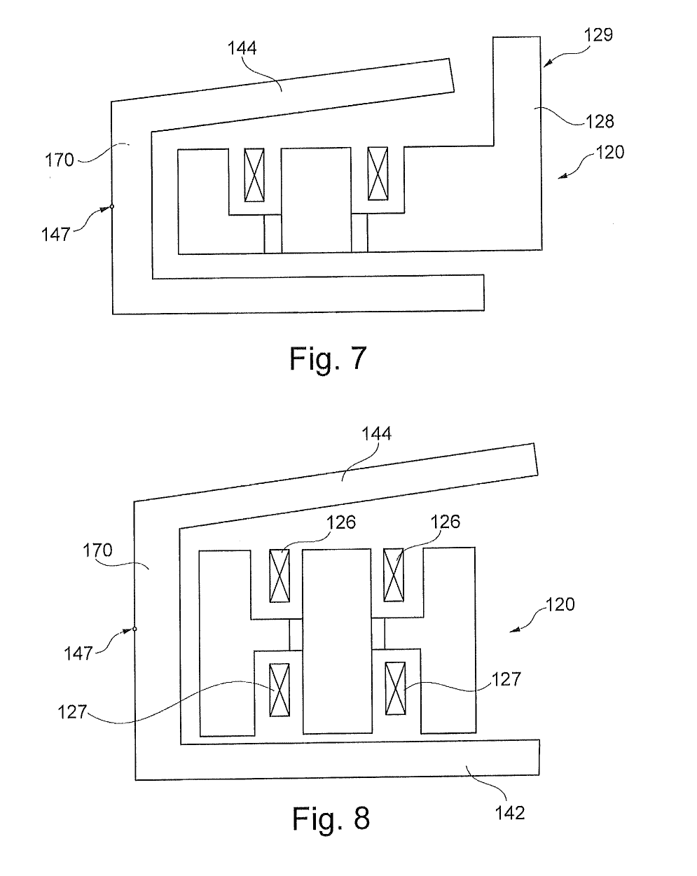

FIG. 7 illustrates an exemplary embodiment of the magnetic actuator similar to the setup depicted in FIG. 6, wherein the flank illustrated in FIG. 7 is elongated towards the movable part.

Thus, the magnetic force generated by the non-movable part 120 and acting on the second element 144 of the movable part is relatively stronger, as the distance between the movable part and the flank 128 is reduced.

When moving towards the non-movable part, the movable part rotates around the rotational axis 147.

FIG. 8 illustrates an exemplary embodiment of a magnetic actuator wherein the non-movable part includes a first coil 126 and second coil 127.

The first coil 126 is adapted to attract the second element 144 towards the non-movable part 120 and thus bringing the magnetic actuator in the on-position, whereas the second coil 127 is adapted to attract the first element 142 to move towards the non-movable part to bring the magnetic actuator in the off-position.

When moving the movable part towards the non-movable part, the movable part rotates around the rotational axis 147.

The U-form-shaped or horseshoe-shaped movable part as depicted in FIG. 6, FIG. 7 and FIG. 8 can have the exemplary advantage that only one hinge for providing a rotational axis 147 is used for the movable part, thus reducing the number of involved parts.

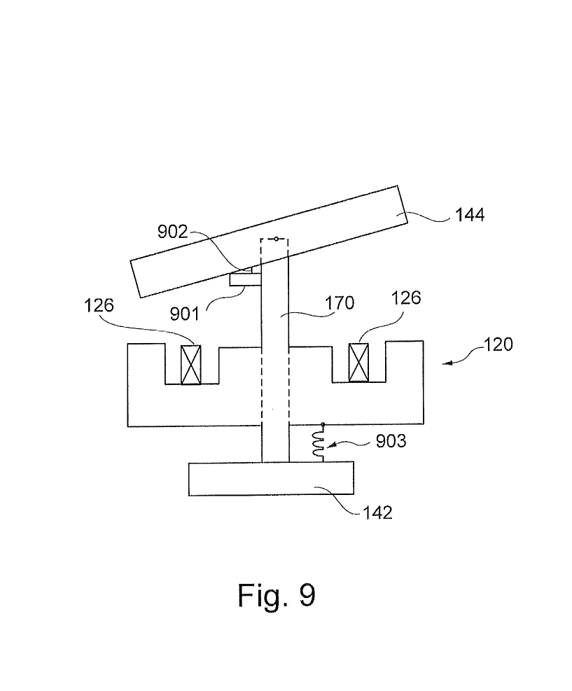

FIG. 9 illustrates an exemplary embodiment of a magnetic actuator, wherein the movable part includes a stopping element 901, a first spring 902, and a second spring 903.

The first spring 902 is arranged between the second element 144 and the stopping element 901 such that the first spring brings the second element 144 in an inclined position with respect to the longitudinal axis of the shaft 170, and wherein the stopping element 901 is arranged to hold the second element 144 in a predetermined inclined position.

When attracted by and moving towards the non-movable part 120, the second element 144 will rotate against the tension force of the first spring 902 until the second element 144 lies planar against the non-movable part 120.

Furthermore, the movable part is moved against the tension force of the second spring 903 when performing a switching operation.

As long as the non-movable part attracts the movable part, the movable part will be held in the on-position. When the magnetic force acted on the movable part is disabled, the second spring 903 will bring the movable part back into the off-position, and the first spring 902 will bring the second element 144 in the inclined position. Therefore, the second spring 903 exerts a tension force from the non-movable part to the first element 142.

FIG. 9 depicts a magnetic actuator, wherein the second spring 903 pulls the first element 142 towards the non-movable part, wherein the magnetic force is adapted to pull the second element towards the non-movable part. As a matter of course, it may also be possible that the second spring pulls the second element 144 towards the non-movable part and that the magnetic force is adapted to pull the first element towards the non-movable part.

In the claims, the word “comprising” does not exclude other elements or steps, and the indefinite article “a” or “an” does not exclude a plurality. It should be noted that the above features of various embodiments may also be combined. The combinations of features disclosed herein may also lead to synergetic effects recognized by those skilled in the art and encompassed by the claims, even if not explicitly described herein in detail. Reference signs in the description and the claims are not to be seen as limitations of the invention and the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A magnetic actuator for a circuit breaker, comprising:
a non-movable part; and
a movable part having a first element and a second element, the movable part being movable in a first direction from an off-position to an on-position;
wherein in the off-position the non-movable part is adjacent to the first element;
wherein in the on-position the non-movable part is adjacent to the second element;
wherein the first element and/or the second element are configured to rotate around a rotational axis when a magnetic force generated by the non-movable part acts on the first element and/or the second element and the movable part moves from the off-position to the on-position; and
wherein in the off-position or in the on-position the first direction is not perpendicular to a surface of the first element and/or the second element facing the non-movable part.

2. The magnetic actuator according to claim 1,
wherein the first element and the second element are interlinked so that the first element and the second element will both rotate around the rotational axis during operation.

3. The magnetic actuator according to claim 1, wherein the movable part comprises:
a mechanical interlink, and wherein the first element and the second element are interlinked with the mechanical interlink for coupling the first element to the second element.

4. The magnetic actuator according to claim 3, wherein the mechanical interlink is a shaft having a longitudinal axis which runs parallel to the first direction;
wherein the shaft is arranged between the first element and the second element; and
wherein the shaft is connected to the first element and/or the second element by a hinge.

5. The magnetic actuator according to claim 3, wherein the first element and/or the second element comprises;
an oblong hole, wherein a part of the mechanical interlink is configured adapted to move in the oblong hole when the first element and/or the second element rotate around the rotational axis when moving into the first direction.

6. The magnetic actuator according to claim 1, wherein the movable part comprises:
at least one stop element for stopping a rotation of the first element and/or the second element around the rotational axis, the stop element being configured to hold the first element and/or the second element in an inclined position relative to the first direction in the on-position and the off-position, respectively.

7. The magnetic actuator according to claim 6, wherein the movable part comprises:
at least one first spring to bring the first element and/or the second element in the inclined position.

8. The magnetic actuator according to claim 1, wherein the non-movable part comprises:
a core element, at least one permanent magnet, and a first coil, configured such that during operation a current which flows through the first coil during operation will generate a magnetic attractive force acting on the second element so that the movable part moves to the on-position.

9. The magnetic actuator according to claim 1, comprising:
at least one flank, wherein the at least one flank is elongated in a direction parallel to the first direction to reduce a distance from the movable part to the non-movable part in order to reduce a magnetic resistance of an air gap between the movable part and the non-movable part.

10. The magnetic actuator according to claim 1, wherein the non-movable part comprises:
a second coil, configured such that a current which flows through the second coil during operation will provide a magnetic attractive force at the first element so that the movable part moves to the off-position.

11. The magnetic actuator according to claim 1, comprising:
at least one second spring, wherein the second spring is arranged to move the movable part to the off-position.

12. Circuit breaker, comprising:
a magnetic actuator according to claim 1.

13. The magnetic actuator according to claim 2, wherein the movable part comprises:
a mechanical interlink, and wherein the first element and the second element are interlinked with the mechanical interlink for coupling the first element to the second element.

14. The magnetic actuator according to claim 13, wherein the mechanical interlink is a shaft having a longitudinal axis which runs parallel to the first direction;
wherein the shaft is arranged between the first element and the second element; and
wherein the shaft is connected to the first element and/or the second element by a hinge.

15. The magnetic actuator according to claim 14, wherein the first element and/or the second element comprises;
an oblong hole, wherein a part of the mechanical interlink is configured adapted to move in the oblong hole when the first element and/or the second element rotate around the rotational axis when moving into the first direction.

16. The magnetic actuator according to claim 15, wherein the non-movable part comprises:
a core element, at least one permanent magnet, and a first coil, configured such that during operation a current which flows through the first coil during operation will generate a magnetic attractive force acting on the second element so that the movable part moves to the on-position.

17. The magnetic actuator according to claim 16, comprising:
at least one flank, wherein the at least one flank is elongated in a direction parallel to the first direction to reduce a distance from the movable part to the non-movable part in order to reduce a magnetic resistance of an air gap between the movable part and the non-movable part.

18. The magnetic actuator according to claim 17, wherein the non-movable part comprises:
a second coil, configured such that a current which flows through the second coil during operation will provide a magnetic attractive force at the first element so that the movable part moves to the off-position.

19. The magnetic actuator according to claim 18, comprising:
at least one second spring, wherein the second spring is arranged to move the movable part to the off-position.

20. Circuit breaker, comprising:
a magnetic actuator according to claim 19.
